(19) United States
(12) Patent Application Publication
(10) Pub. No.: US 2023/0263607 A1
(43) Pub. Date: Aug. 24, 2023

(54) DEVICES AND METHODS OF TREATING ORAL TISSUES

(71) Applicant: PerioTech, LLC, Palm Beach Gardens, FL (US)

(72) Inventors: Richard JOHNSON, Palm Beach Gardens, FL (US); Nicholas PURO, Sunny Isles Beach, FL (US)

(21) Appl. No.: 17/578,282

(22) Filed: Jan. 18, 2022

(51) Int. Cl. A61C 19/06

(52) U.S. Cl. CPC A61C 19/06

(57) ABSTRACT

A device and method for treating periodontal pockets following a dental procedure for treating periodontal pockets in a patient includes a vibrational dental device having a mouthpiece for contacting the dentition. Instructions are provided for using the vibrational dental device by placing the mouthpiece over the dentition, applying a vibratory force during a predetermined number of sessions throughout a predetermined treatment period, wherein the recovery of the periodontal pockets is enhanced and/or accelerated compared to without vibratory treatment.

### TECHNICAL FIELDS

This disclosure concerns treatments of periodontal conditions, more specifically, a method to facilitate the treatment of periodontal pockets and general oral health using mechanical vibration.

### BACKGROUND

Periodontal pockets are spaces or openings surrounding the teeth under the gum line. These pockets provide space for the accumulation of bacteria and plaque leading to a higher probability of infection. Periodontal pockets typically form from gingivitis, a mild form of gum disease in response to bacterial biofilm (e.g., plaque) that affects the gingiva, the part of the gum that surrounds the teeth. If untreated, gingivitis can cause damage to the gingiva and the formation of periodontal pockets, which accompany periodontitis, or gum disease, which is a serious oral infection that damages and erodes the soft tissue and, without treatment, can affect periodontal bones leading to loose teeth and tooth loss. Periodontal pockets can also cause red pus-filled gums, pain, and severe and persistent halitosis.

Periodontal pockets can in many instances be treated and reversed with good oral hygiene following dental treatments to remove plaque, tartar and bacteria. Scaling and root planning removes bacterial products and inflammation byproducts and smooths the surface of the teeth to discourage buildups. Topical antibacterial rinses or gels can also be used to help combat bacteria and reduce inflammation. More involved surgical flap procedures may also be indicated where advanced pockets have formed but teeth may be saved.

Periodontal pockets are measured in millimeters. Pockets from 1 to 3 mm are generally considered normal, but larger pockets signal trouble. A toothbrush has an effective depth of about 3 mm, so larger pockets usually require professional intervention. Pockets from 4 to 5 mm indicate early or mild periodontitis, suggesting that gum disease is likely present. Pockets from 5 to 7 mm indicate moderate periodontitis and from 7 to 12 mm advanced periodontitis. Dentists use probes to measure the size and depth of pockets.

Certain individuals are at statistically higher risk for gingivitis and periodontitis. For example, those that have a high-sugar diet, smokers and vapers, users of chewing tobacco or dip. Other risk factors include hormonal changes occurring in women during pregnancy and menopause, diabetes, leukemia, scurvy, and some autoimmune diseases. Certain medications can also create a predisposition to these diseases.

### SUMMARY

According to an exemplary embodiment of the present disclosure, a method for accelerating recovery from one or more periodontal procedures for treating pockets is described. The method includes identifying a patient having undergone a periodontal procedure for treating periodontal pockets, providing to the patient a vibrational dental device having a mouthpiece for contacting the dentition, and providing instructions for using the vibrational dental device. The instruction includes placing the mouthpiece over the dentition and applying a vibratory force during a predetermined number of sessions throughout a predetermined treatment period. The periodontal pockets can be reduced faster than without vibratory treatment.

According to yet another exemplary embodiment of the present disclosure, a method for accelerating recovery from one or more periodontal procedures for treating pockets is described. The method includes identifying a patient having undergone a periodontal procedure for treating periodontal pockets, providing to the patient a vibrational dental device having a mouthpiece for contacting the dentition proximate to the treated pocket, and providing instructions for using the vibrational dental device. The instruction includes placing the mouthpiece over the dentition and applying a vibratory force during a predetermined number of sessions throughout a predetermined treatment period. The periodontal pockets can be reduced faster than without vibratory treatment. Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

### BRIEF DESCRIPTION OF THE DRAWINGS

The accompanying drawings constitute a part of this specification. The drawings illustrate several embodiments of the present disclosure and, together with the description, serve to explain the principles of the disclosed embodiments as set forth in the accompanying claims.

The drawings are not necessarily to scale or exhaustive. Instead, emphasis is generally placed upon illustrating the principles of the inventions described herein. The accompanying drawings, which are incorporated in and constitute a part of this specification, illustrate several embodiments consistent with the disclosure and together with the description, serve to explain the principles of the disclosure. In the drawings:

FIG. 1A depicts an illustrative vibrational dental device according to one aspect of the disclosure;

FIG. 1B depicts an illustrative vibrational dental device, such as that depicted in FIG. 1A placed in the mouth of a user, according to one aspect of the disclosure;

FIG. 2A depicts a plan view of a dental mouthpiece according to an exemplary embodiment;

FIG. 2B is a side view of an illustrative intraoral dental device according to an exemplary embodiment;

FIG. 2C is a partial side view of an illustrative dual-arch dental device according to an exemplary embodiment;

FIG. 2D is a side view of a further illustrative intraoral dental device according to an exemplary embodiment;

FIG. 2E depicts exemplary pillar shapes according to further exemplary embodiments of the disclosure;

FIGS. 3A-3B are front and schematic cross-sectional views respectively of an upper dental arch engaging exemplary embodiments of the disclosure;

FIGS. 3C-3D are top and schematic cross-sectional views respectively of an upper dental arch engaging exemplary embodiments of the disclosure;

FIG. 4 depicts an illustrative dental device according to a further exemplary embodiment of the disclosure;

FIG. 5 is a chart showing prophetic improvements in pocket depths after three months of treatment according to embodiments of the present disclosure.

Reference will now be made in detail to exemplary embodiments. Unless otherwise defined, technical or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

### DETAILED DESCRIPTION

It is to be understood that both the foregoing general description and the following detailed description are exemplary and explanatory only and are not restrictive of the claims.

The disclosed embodiments relate to devices, systems, and methods for accelerating treatment of periodontal pockets and accelerating the rate of shrinkage of periodontal pockets or acceleration of the return of enlarged periodontal pockets to normal. Advantageously, embodiments of the present disclosure can be implemented to treat periodontal pockets more quickly than without. This is surprising in light of the generally held view that mechanical disruption of the pocket site is detrimental to healing and recovery following dental or periodontal procedures to treat the pockets such as scaling, planing and/or flap surgery. Further advantageously, embodiments of the present disclosure can be implemented to decrease the load of microbes and reduce biofilm formation in the pocket.

Compared to without treatment, low-magnitude high-frequency vibration (LMHFV) can increase the speed and/or quality of the process of pocket reduction, either with or without surgery, reducing the propensity toward bacteria accumulation and further complications. Results can be obtained either when used along with root planing or scaling or other surgical intervention, or when used alone.

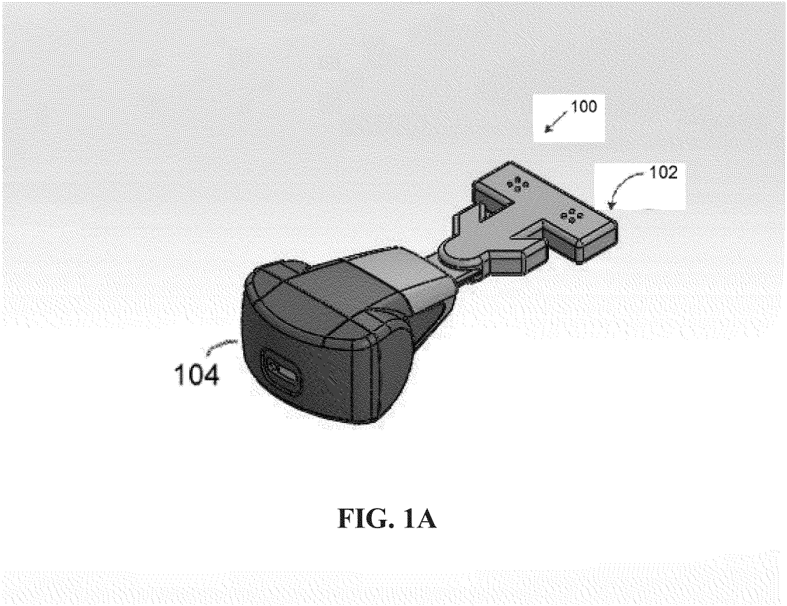

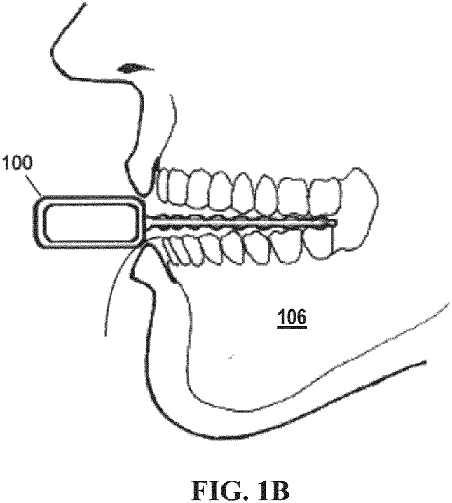

LMHFV, as indicated may be utilized immediately following a dental procedure related to periodontal pockets. In an aspect, with reference to FIGS. 1A and 1B, use of the device 100 providing LMHFV for 5 minutes daily accelerates pocket recovery, contributing to better overall oral health.

Described herein are LMHFV dental devices, which in certain embodiments include a mouthpiece configured to transmit vibration to all or a portion of the patient’s teeth.

Described herein are LMHFV dental devices, which in certain embodiments include a mouthpiece configured to transmit vibration to all or a portion of the patient’s teeth that can reduce the microbial load and prevent biofilm formation in a periodontal pocket.

Referring to FIGS. 1A-1B, an exemplary dental device 100 includes a mouthpiece 102 operatively connected to a housing 104. The mouthpiece 102 can be separable from the housing 104 for interchangeability between users or for ease of cleaning. The mouthpiece 102 can include one or more oral tissue-contacting portion, such as a biteplate or probe for contacting teeth, gums or other oral tissues. As shown, in FIG. 1A, the mouthpiece can include a biteplate which can be appropriately shaped to cover occlusal surfaces of some or all of a patient’s dentition. Other shapes for the mouthpiece are possible. For example, the mouthpiece can be configured to abut the lingual and buccal lateral sides of the alveolar ridge either with or without occlusal contact or, when no teeth are present, contact with gums overlying the alveolar ridge. A vibration generator can be located in the mouthpiece 102 or the housing 104 to vibrate the mouthpiece 102. The housing 104 can also include the electronics to run the motor the vibrator, collect usage and device operation data, collect data from sensors in the mouthpiece or base, and store data in memory. The housing 104 can include a data interface which can be wired or wireless to allow a data connection to other devices. The housing 104 can also include a power interface to allow charging of any onboard power sources, such as batteries or capacitor banks. The mouthpiece 102 can be electrically interconnected to the housing 104. FIG. 1B depicts an illustrative dental device 100, such as that described above with reference to FIG. 1A, inserted in the mouth of a human user 106 and engaging the occlusal surfaces of the molars. The mouthpiece of the dental device 100 can, as described above, be sized and shaped to contact any dental tissue, including some or all of the teeth, specific regions of the gums, or both.

As is known in the art, the vibration generator can include an electric motor connected to an eccentric weight, or can be a piezo generator, as well as other known expedients. Accordingly, when the mouthpiece 102 is placed in a patient’s mouth and the dental device is 100 turned on, the vibration of the mouthpiece 102 will place vibratory force repetitively on the teeth and/or other oral tissues.

In yet another aspect, LMHFV can be performed after a nonsurgical or surgical approach to gingivitis or periodontitis is performed. LMHFV can also be performed when any oral or facial procedure or surgery is performed and results a need for grafting, such as root canals, scaling and planing, etc. LMHFV stimulates organization of soft tissues to improve soft tissue reattachment, accelerate angiogenesis, and therefore improve oral health. LMHFV also has an anti-inflammatory effect on the soft and hard tissue by accelerating and stimulating host factors to improve healing and organization, and by depressing factors that may cause inflammation. In some embodiments, accelerated healing and organization may result better pain management of the patient.

In some embodiments, the patient can be instructed to use the appliance for a prescribed time and duration to augment a grafted implant site. In an example, the patient can be instructed to use the appliance for example, five minutes daily, over a period of time, for example four months.

The vibration can be applied along multiple axes or selected to be primarily on a single axis. The primary anatomic reference directions with reference to a standing human are superior-inferior (up and down), anterior-posterior (front to back), medial-lateral (side to side). Because mastication places loading on oral structures primarily in the superior-inferior direction through mandibular action, it may be advantageous to choose vibrational loading along other axes either separately or in combination.

### Vibrational Dental Devices

According to an aspect of the present disclosure, a vibrational dental device that vibrates at one or more predetermined frequencies is provided. In some embodiments the vibrational frequency is fixed within a lower bound and an upper bound. The lower bound can be greater than about 110 Hz, 105 Hz, 100 Hz, 95 Hz, 90 Hz, 85 Hz, 80 Hz, 75 Hz, 70 Hz, 65 Hz, 60 Hz, 55 Hz, 50 Hz, 45 Hz, or less. The upper bound can be greater than about 115 Hz, 120 Hz, 125 Hz, 130 Hz, 135 Hz, 140 Hz, 145 Hz, 150 Hz, or more. In some embodiments, the frequency varies within a lower and an upper bound. In some embodiments two or more frequencies, fixed or varying, are employed.

In some embodiments the duration of a treatment session can be specified to be greater than about 30 seconds, 1 min, 2 min, 3 min, 4 min, 5 min, 6 min, 7 min, 8 min, 9 min, 10 min, 11 min, 12 min, 13 min, 14 min, 15 min, 16 min, 17 min, 18 min, 19 min, 20 min, or more; or specified to be less than about 20 min, 19 min, 18 min, 17 min, 16 min, 15 min, 14 min, 13 min, 12 min, 10 min, 9 min, 8 min, 7 min, 6 min, 5 min, 4 min, 3 min, 2 min, 1 min, 30 seconds, or less.

FIG. 1 depicts a vibrational dental device according to an example. The vibrational dental device can include a mouthpiece and a vibrational source connected to each other. The mouthpiece is configured to be provided between the occlusal surfaces of a user’s teeth, and to be bite down by the user to contact the user’s dentition during the treatment. The mouthpiece can cover at least the teeth around which pocket reduction is desired. The vibrational source is configured to provide vibration to the mouthpiece at one or more preset frequencies and acceleration.

To achieve the maximum desired results of periodontal pocket recovery, further studies are still needed to optimize the parameters of LMHFV. Such parameters may include frequency, acceleration, and dosage. Dosage may include duration per use, number of uses per day, or number of days of use, either consecutively or at a certain schedule.

In some embodiments, the vibrational source may be connected to the mouthpiece in such way that the vibration provided is in the sagittal plane of a user’s mouth. A motor may be included in the vibrational source to provide such vibration. The motor may be of any suitable type known in the art. The motor, when in use, may be configured to provide vibration at a frequency as disclosed herein. The motor, when in use, may be further configured to provide vibration at an acceleration magnitude. In some embodiments the mouthpiece of a dental vibration device can have an acceleration within a lower bound and an upper bound. The lower bound can be greater than about 0.010 G, 0.015 G, 0.020 G, 0.025 G, 0.030 G, 0.035 G, 0.040 G, 0.045 G, 0.050 G, 0.055 G, 0.060 G, or more; or less than about 0.060 G, 0.055 G, 0.050 G, 0.045 G, 0.040 G, 0.035 G, 0.030 G, 0.025 G, 0.020 G, 0.015 G, 0.010 G, or less. The upper bound can be greater than about 0.07 G, 0.08 G, 0.09 G, 0.10 G, 0.11 G, 0.12 G, 0.13 G, 0.14 G, 0.15 G, or more; or less than about 0.15 G, 0.14 G, 0.13 G, 0.12 G, 0.11 G, 0.10 G, 0.09 G, 0.08 G, 0.07 G, or less.

The motor may be assembled into the vibrational source in an orientation that may provide vibration in such ways.

In some embodiments, sensors may be added to the vibrational dental device, either on the vibrational device, or on the mouthpiece. The sensors may be configured to detect and monitor the parameters of the vibration, for example, frequencies and acceleration magnitudes. The sensors may also be configured to detect if the user has bitten down on the mouthpiece correctly. The sensors may be accelerometers, gyroscopes, proximity sensors, pressure sensors, humidity sensors, temperature sensors, or any combinations of them.

In some embodiments, the mouthpiece could be in contact with at least the teeth or implant near which graft conversion acceleration is needed. The mouthpiece may be configured to be placed in contact with a user’s dentition, between and clamped down by both occlusal surfaces of the dentition. The mouthpiece can include ridges or be without ridges. The mouthpiece can cover the entire dentition, or only a part of the dentition. The shape of the mouthpiece can be customized to cover only selected teeth or implants.

In some embodiments, the vibratory dental appliance can reduce the oral microbial load, contributing to recovery of a dental pocket. It is generally known that vibration can stimulate the saliva glands for salivary secretion, and according to one study vibration at 89 Hz was found to be efficient. Saliva is rich in antimicrobial compounds that exert direct antimicrobial activity, such as enzymatic breakdown of bacterial cell walls via lysozymic action. Saliva also assists by sequestering iron through the action of lactoferrin, an iron-binding salivary glycoprotein, which helps prevent the formation of biofilms. In addition, the antimicrobial peptides in saliva use their positive charge to bind to the negatively charged surfaces of microbial membranes, forming pores that ultimately result in lethal efflux of vital cell constituents. Diverse peptides such as defensins, cathelicidins, and histatins, can also interact synergistically in limiting microbial colonization. Advantageously, an exemplary embodiment of the dental appliance increases the amount of saliva in the oval cavity and provides agitation of the saliva to urge circulation around and into the pocket. The result is a novel increase of antimicrobial properties via salivary circulation near the periodontal pocket, so as to reduce the microbial load in the periodontal pocket.

In some embodiments, the vibratory dental appliance can reduce biofilm formation. The Oral Microbiome Database today lists 775 microbial species, which varies throughout the oral cavity. For instance, the microbiota of the tongue resembles that present in saliva, but differs from that found on the teeth and dental roots. The polymicrobial nature of biofilm formation is complicated, and further many oral biofilms are beneficial. While not completely understood, the complex interaction between constituents of microbiota can lead to increases in pathogenicity. Without being bound to theory, it is believed that the utilization of vibration energy, transmitted through oral structures and the surrounding salivary fluid media, interferes with the adhesion of microorganisms to oral surfaces. The effectiveness of vibration on inhibiting and disrupting biofilm formation or oral structures may be a function of the effects of vibration on differential effects on gram-positive and gram-negative bacteria species, recognizing that gram-positive species such as cocci are thought to be early initiators of biofilm formation. Further advantageously, unattached microorganisms are more vulnerable to the antimicrobial properties of saliva. Preventing adhesion and associated attachment to oral substrates interrupts the complex sequence of gene expression reprogramming, and synthesis of the corresponding protein products involved in biofilm development.

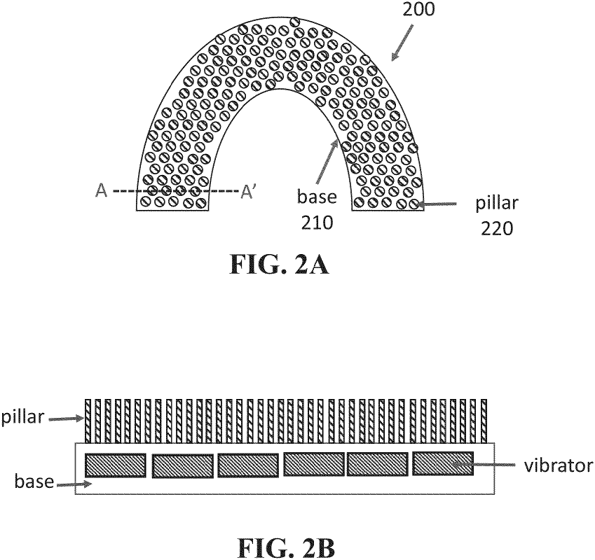

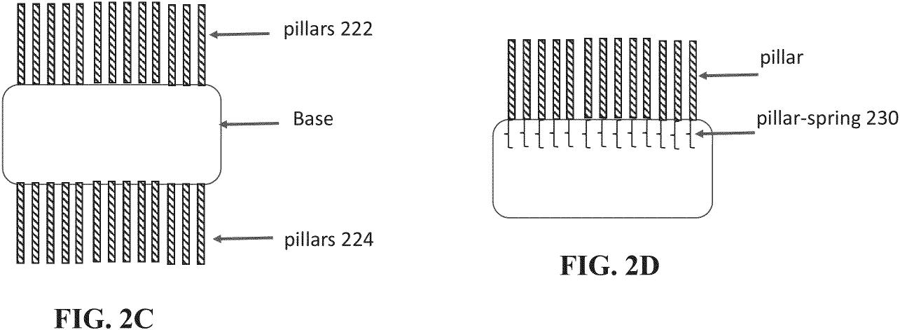

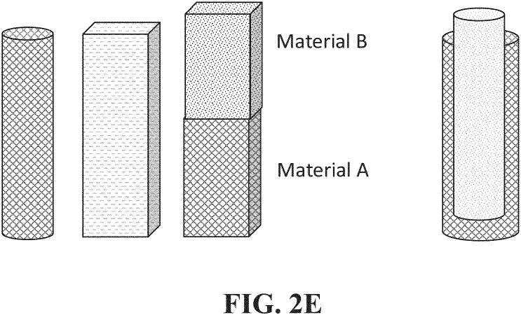

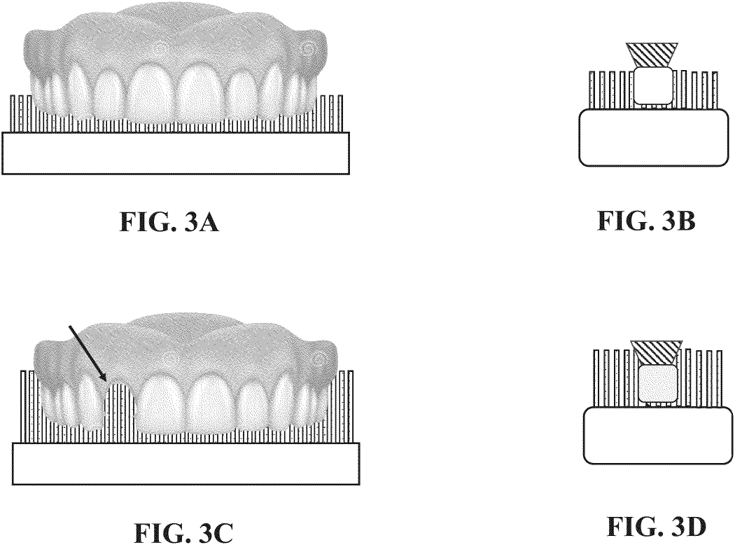

Turning to FIGS. 2A-2E, a further exemplary dental appliance 200 is depicted. The illustrative device 200 can include a base 210 and an array of bristles or pillars 220 covering the base. In an aspect, the array of pillars 220 are configured to substantially envelope one or more teeth according to an example. In some embodiments, dental appliance 200 can include a first set of pillars 222 configured to interface with a first set of teeth and a second set of pillars 224 configured to interface with a second set of teeth. In some embodiments, the array of pillars can protrude substantially parallel and vertically from the base. Subsets of pillars may also be non-parallel and apply angular stresses on the teeth. In some embodiments, each pillar can be movable with a spring 230 configured to retract when engaged with a tooth (FIG. 2D, see also FIGS. 3A-3D). FIG. 2E depicts examples of pillar shapes, having one or more materials, and configured to modify torsion on the teeth and gums and selectively enhance and/or dampen vibrations.

In some embodiments, the appliance can be configured to engage with a patient’s teeth alone (FIGS. 2A-2B) or can be configured to engage with a patient’s teeth and gums (FIGS. 3C-3D). As shown in FIG. 3C, the array of pillars 220, 222, 224 may gently engage with the gum line at or below the gingival margin to provide stimulation to the soft tissue. Such gentle stimulation can help to increase blood flow and other cells of repair to the site, in addition to that provided by vibration conducted through neighboring teeth and tissue structures. The appliance can be configured to stimulate one or more teeth, the gum line only, or both one or more teeth and the gumline.

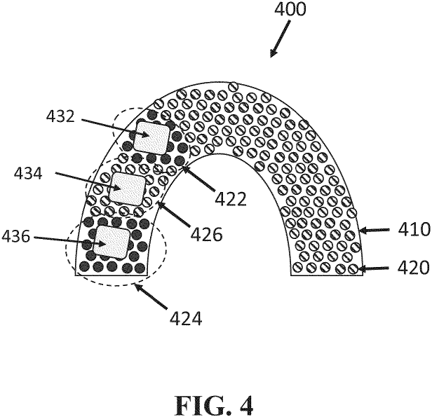

Turning to FIG. 4, in some embodiments, a dental appliance 400 can be configured to isolate one or more teeth or pocket reduction sites for stimulation therapy. In an example, the appliance 400 can be configured to control stimulation energy to a subset of the array of pillars. In an example, a first set of pillars 422 and a second set of pillars 424 can be configured to immobilize or isolate stimulation from at least one tooth 432 and 436 while stimulation energy is being applied to an active set of pillars 426 directed at engaging a tooth 434 or gum site.

In some embodiments, a granular dental appliance 400 can include a base portion 410 including a stimulation source such as a vibration source, a plurality of pillars 420 in communication with the base and configured to engage with at least one tooth 432, 434, and 436 and at least a portion of a gum, where a first set of pillars of the plurality of pillars is configured to immobilize or dampen vibration of at least a first tooth 432 or portion of gum, and a second set of pillars of the plurality of pillars is configured to mobilize or enhance vibration of at least a second tooth 434 or portion of gum, which can also be seen in FIGS. 3C to 3D.

According to yet another aspect of the present disclosure, a method for accelerating pocket recovery is described. The method including providing a vibratory dental appliance, comprising a base including a vibration source, and a plurality of pillars extending from the base and configured to engage with at least one tooth and at least a portion of a gum, determining at least one of an orientation of at least one tooth and a gum line, controlling a first vibration to a first set of pillars of the plurality of pillars, the first vibration is configured to immobilize or dampen vibration of at least a first tooth or portion of gum, and controlling a second vibration to a second set of pillars of the plurality of pillars, the second vibration is configured to mobilize or enhance vibration of at least a second tooth or portion of gum.

### Method For Accelerating Periodontal Pocket Recovery

According to yet another aspect of the present disclosure, a method for accelerating periodontal pocket recovery is described. The method includes providing the mouthpiece of the vibrational dental device to a user and providing instructions to the user. The instruction may include placement guidelines and dosage information. The dosage information may include duration of each treatment session, number of sessions in a day, number of days, etc. For example, the instruction may instruct a user to use the vibrational dental device for number of times per day. In some embodiments the treatment frequency can be specified to be once per day, twice per day, 3 times per day, 4 times per day, 5 times per day, 6 times per day, 7 times per day, 8 times per day, 9 times per day, or more. In some embodiments the duration of treatment can be specified to be about 1 day, 1 week, 2 weeks, 3 weeks, 1 month, 2 months, 3 months, 4 months, 5 months, 6 months, 7 months, 8 months, 9 months, 10 months, 11 months, 1 year, or more.

In some embodiments, the method may further include configuring the vibrational source providing an axial vibratory force to the mouthpiece. The axial vibratory force may be eventually applied to the dentition through the mouthpiece, which is clamped down by the teeth. The vibratory force (e.g., acceleration magnitudes, frequencies, etc.) can be adjusted by selecting preset values, or fine-tuned by users, technicians, or healthcare professionals.

According to yet another aspect of the present disclosure, a method for periodontal pocket recovery is described. The method includes steps of identifying an implant site, providing a graft at the implant site, applying a stimulus to a portion of the implant site, sensing a baseline response at the implant site, applying one or more vibration sessions over a period of time, sensing at least one second response at the implant site, and determining an inflammation status based on a comparison between the baseline response and one or more second responses. Inflammation status could be detected using numerous modalities, including for example by reflectometry. In some embodiments, the method may further include applying stimulus based on detected inflammation status.

In some embodiments, the stimulus applied can be one or electrical energy, light energy, and a mechanical dynamic load that is either isotonic or isometric. In addition, the stimulus can be applied to a portion of the implant site symmetrically or asymmetrically on one side of the implant site or across the implant site such as across a facial side and lingual side or mesial side and distal side. In some embodiments, sensing a baseline response can include information informing an inflammation status at a gum line.

### EXAMPLES

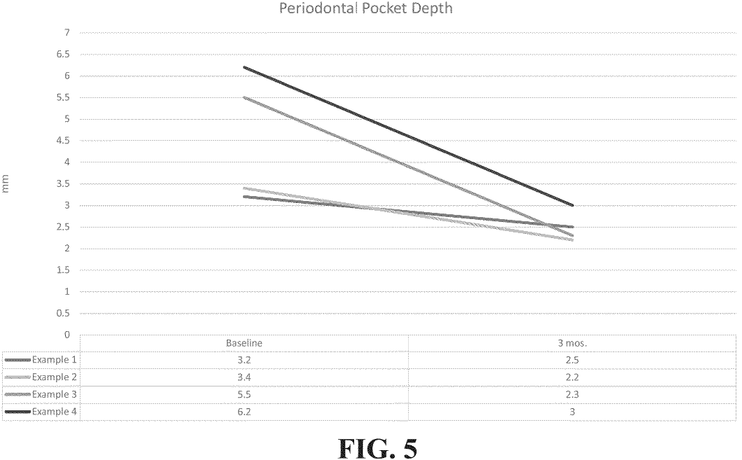

Depicted in FIG. 5 are prophetic examples of results obtained by use of exemplary methods and devices according to the present disclosure. After three months of use, periodontal pocket depth decreases without surgical intervention, for example debridement or root planing. Microbial load in the pocket and on the oral surfaces of the pocket are reduced. It is predicted that illustrative pocket depth reduction can be obtained on maxillary or mandibular teeth, on the labial or buccal lateral sides, and without regard to gingival biotype. Recovery is improved on shallow or deep gingival pockets. The devices and methods of the instant specification can also be used as an adjunct to surgical intervention, with the expectation of faster recovery than without vibration.

The foregoing descriptions have been presented for purposes of illustration. They are not exhaustive and are not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps or inserting or deleting steps.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

As used herein, unless specifically stated otherwise, the terms “and/or” and “or” encompass all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the disclosure disclosed herein. It is intended that the specification and examples be considered as exemplary only, with a true scope and spirit of the disclosure being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. A method for recovering periodontal pockets, comprising:
identifying a patient having undergone a periodontal pocket procedure;
providing to the patient a vibrational dental device having a mouthpiece for contacting the dentition; and
providing instructions for using the vibrational dental device, the instruction comprising:
placing the mouthpiece over the dentition;
applying a vibratory force during a predetermined number of sessions throughout a predetermined treatment period;
wherein the periodontal pocket is recovered faster than without vibratory treatment.

2. The method of claim 1, wherein the frequency is ranging from 45 Hz to 150 Hz.

3. The method of claim 1, wherein the duration is ranging from 30 seconds to 20 minutes.

4. The method of claim 1, wherein the acceleration of the mouthpiece ranged from 0.010 G to 0.15 G.

5. The method of claim 2, wherein the frequency is about 113 Hz.

6. The method of claim 1, wherein a dimension of a periodontal pocket is reduced faster compared to than without vibratory treatment.

7. The method of claim 1, wherein the microbial load is decreased compared to without vibratory treatment.

8. The method of claim 1, wherein the biofilm formation is reduced compared to without vibratory treatment.

9. The method of claim 1, wherein the periodontal pocket procedure is non-surgical.

10. The method of claim 1, wherein the periodontal pocket procedure is surgical.

11. The method of claim 1, wherein the session time is from 30 seconds to 20 minutes.

12. The method of claim 1 where sessions are repeated daily/every other day/semi-weekly/weekly.

13. The method of claim 1, wherein the treatment period is from 1 day to 1 year.

14. The method of claim 1, further comprising:
determining if the actual frequency or acceleration is above or below the set frequency or the set acceleration while the mouthpiece is vibrated against the occlusal surfaces of the patient’s teeth; and
adjusting the actual frequency or actual acceleration based upon the determination.

15. A method for recovering periodontal pockets, comprising:
identifying a patient having undergone a periodontal pocket procedure;
providing to the patient a vibrational dental device having a mouthpiece for contacting the dentition and/or the dental implant; and
providing instructions for using the vibrational dental device, the instruction comprising:
placing the mouthpiece over the dentition;
applying a vibratory force during a predetermined number of sessions throughout a predetermined treatment period;
wherein the periodontal pocket is recovered faster than without vibratory treatment.
